(19) United States
(12) Patent Application Publication
(10) Pub. No.: US 2008/0238833 A1
(43) Pub. Date: Oct. 2, 2008

(54) LIGHT EMITTING DISPLAY DEVICE

(75) Inventors: Kosaku Hioki, Ogaki-shi (JP); Takashi Ogawa, Anpachi-gun (JP)

Correspondence Address: CANTOR COLBURN, LLP, 20 Church Street, 22nd Floor, Hartford, CT, 06103, US

(73) Assignees: SANYO ELECTRIC CO., LTD., Osaka (JP); SANYO SEMICONDUCTOR CO., LTD., Gunma (JP)

(21) Appl. No.: 12/057,802

(22) Filed: Mar. 28, 2008

(30) Foreign Application Priority Data
Mar. 28, 2007 (JP) 2007-086007

(51) Int. Cl. G09G 3/30

(52) U.S. Cl. 345/76

(57) ABSTRACT

An inspection display signal is supplied to a pixel to be inspected so that a light emitting element operates, and a current flowing through the light emitting element is detected. An element current detection signal having a number of bits which is less than a number of bits of a display data signal generated to be supplied to each pixel based on a video signal is stored in a memory according to a characteristic such as a change range and precision of the obtained element current and is used for variation correction. For example, only bit positions in which a value may change are stored in consideration of the change allowance range of the ON-current detection signal, so that a storage capacity to the memory is reduced without affecting correction precision of variation.

### CROSS-REFERENCE TO RELATED APPLICATIONS

The entire disclosure of Japanese Patent Application No. 2007-086007 including specification, claims, drawings, and abstract is incorporated herein by reference.

### BACKGROUND OF THE INVENTION

1. Field of the Invention

The present invention relates to a light emitting display device having a light emitting element such as an electroluminescence element in each pixel, and in particular, to a display device having correction of display variation.

2. Description of the Related Art

Light emitting display devices in which an electroluminescence (hereinafter referred to as “EL”) element which is a self-emissive element is employed as a display element in each pixel are expected as a flat display apparatus of the next generation, and are being researched and developed.

After an EL panel is created in which an EL element and a thin film transistor (hereinafter referred to as “TFT”) or the like for driving the EL element for each pixel are formed on a substrate such as glass and plastic, the light emitting display device is subjected to several inspections and is then shipped as a product.

In a current active matrix EL display device having a TFT in each pixel, display unevenness due to the TFT, in particular, brightness variation due to variation in a threshold value Vth of the TFT, is caused, which is a major cause of reduction in yield. Improvement in yield of such a product is very important, and it is required to reduce display defects and display unevenness (display variation) through improvements in element design, material, manufacturing method, etc. In addition, JP 2005-316408 A (hereinafter referred to as “Reference Document 1”) attempts, when a display unevenness or the like occurs, to correct the display unevenness or the like to realize a satisfactory panel.

In Reference Document 1, an EL panel is allowed to emit light and the variation in the brightness is measured, and a data signal (video signal) to be supplied to the pixel is corrected. In addition, as another method, a method is proposed in which a circuit which corrects the variation of Vth of an element driving transistor which controls a current to be supplied to the EL element is provided in each pixel.

The method as described in Reference Document 1 in which light is emitted from the EL panel and the light emission is imaged by a camera to measure the brightness cannot be executed after shipping, and, thus, correction corresponding to the change with elapse of time of the panel cannot be executed. In addition, when the resolution of the EL panel is increased and the number of pixels is increased, the number of pixels to be measured and corrected in the measurement of the brightness variation for each pixel is increased, and, thus, the resolution of the camera must be increased and a capacity of a storage for correction information must also be increased.

In addition, even when the circuit element for compensating Vth is not incorporated into the pixel, there is a very strong desire to correct the display unevenness due to variation in Vth of TFT, and, in particular, it is desired to execute the correction at all times.

### SUMMARY OF THE INVENTION

An advantage of the present invention is that a light emitting display device is provided in which display variation can be measured even after shipping and the display variation can be corrected.

According to one aspect of the present invention, there is provided a light emitting display device comprising a display section having a plurality of pixels arranged in a matrix form, a variation detecting unit which detects an inspection result of display variation in the plurality of pixels, and a correcting unit which corrects the display variation, wherein each of the plurality of pixels in the display section comprises an electroluminescence element and an element driving transistor which is connected to the electroluminescence element and which controls a current flowing through the electroluminescence element, the variation detecting unit comprises an inspection signal generating unit which generates an inspection signal to be supplied to a pixel of an inspection row and which supplies the inspection signal to the pixel of the inspection row at a predetermined timing during execution of display corresponding to a video signal, a current detecting unit which detects a current flowing through the electroluminescence element generated corresponding to the inspection signal and which outputs a current detection signal, and a memory unit which stores digital data corresponding to the current detection signal, the correcting unit executes a variation correction according to each characteristic of the plurality of pixels on a digital data signal obtained from the video signal based on the digital data stored in the memory unit and generates a display data signal to be supplied to the plurality of pixels, and the memory unit stores, according to a change characteristic of the current detection signal, digital data having a smaller number of bits than that of the display data signal.

According to another aspect of the present invention, there is provided a light emitting display device comprising a display section having a plurality of pixels arranged in a matrix form, a variation detecting unit which detects an inspection result of display variation in the plurality of pixels, and a correcting unit which corrects the display variation, wherein each of the plurality of pixels in the display section comprises a light emitting element and an element driving transistor which is connected to the light emitting element and which controls a current flowing through the light emitting element, the variation detecting unit comprises an inspection signal generating unit which generates, as an inspection signal to be supplied to a pixel of an inspection row, an inspection ON signal which sets the light emitting element to an emission level and an inspection OFF signal which sets the light emitting element to a non-emission level, a current detecting unit which detects an ON-current flowing through the light emitting element when the inspection ON signal is applied and an OFF-current when the inspection OFF signal is applied and which obtains an ON-current detection signal and an OFF-current detection signal, an analog-to-digital converter which converts the ON-current detection signal and the OFF-current detection signal into digital data, respectively, and a memory unit which stores digital data corresponding to an ON-OFF current difference between a digital ON-current detection signal and a digital OFF-current detection signal, the correcting unit executes a variation correction according to each characteristic of the plurality of pixels on a digital data signal obtained from the video signal based on the digital data corresponding to the ON-OFF current difference and generates a display data signal to be supplied to the plurality of pixels, and a number of bits of the digital data corresponding to the ON-OFF current difference stored in the memory unit is less than a number of bits of the display data signal.

According to another aspect of the present invention, it is preferable that, in the light emitting display device, a possible range of the digital data corresponding to the ON-OFF current difference is determined based on a change allowance range of the ON-current detection signal and of the OFF-current detection signal, and, when the digital data corresponding to the ON-OFF current difference is represented with N bits, data of bit positions of (N−1)th bit or lower, among the N bits, which may change is stored in the memory unit as the digital data corresponding to the ON-OFF current difference according to the possible range of the digital data corresponding to the ON-OFF current difference.

According to another aspect of the present invention, it is preferable that, in the light emitting display device, the analog-to-digital converter outputs only the data of positions of (N−1)th bit or lower corresponding to the change allowance ranges of the ON-current detection signal and of the OFF-current detection signal as a digital ON-current detection signal and a digital OFF-current detection signal corresponding to the ON-current detection signal and the OFF-current detection signal, respectively.

According to another aspect of the present invention, it is preferable that, in the light emitting display device, the memory unit stores, when the digital data corresponding to the ON-OFF current difference is represented with N bits, data of bit positions of (N−1)th bit or lower, among the N bits, which may change according to a change allowance range of the digital data corresponding to the ON-OFF current difference, as the digital data corresponding to the ON-OFF current difference.

According to another aspect of the present invention, it is preferable that, in the light emitting display device, the analog-to-digital converter outputs, of the N-bit digital data corresponding to the ON-current detection signal and to the OFF-current detection signal, respectively, only the data of bit positions of (N−1)th bit or lower which may change according to the change allowance range of the digital data corresponding to the ON-Off current difference.

According to another aspect of the present invention, it is preferable that the light emitting display device further comprises a calculation unit which determines the digital data corresponding to the ON-OFF current difference based on the digital ON-current detection signal and the digital OFF-current detection signal, wherein, the calculation unit determines the digital data of N bits corresponding to the ON-OFF current difference based on the digital ON-current detection signal and the digital OFF-current detection signal, and the memory unit stores digital data corresponding to the ON-OFF current difference having a number of bits of (N−1) or less obtained by omitting a lower significant bit of the N bits according to a precision of the digital ON-current detection signal and of the digital OFF-current detection signal.

According to another aspect of the present invention, it is preferable that, in the light emitting display device, the analog-to-digital converter converts the ON-current detection signal and the OFF-current detection signal into digital data having a number of bits of (N−1) or lower according at least to a precision of the ON-current detection signal when the number of bits of the display data signal is N, and the memory unit stores digital data corresponding to the ON-OFF current difference having a number of bits of (N−1) or less obtained from the digital ON-current detection signal and the digital OFF-current detection signal having the number of bits of (N−1) or less.

According to another aspect of the present invention, it is preferable that, in the light emitting display device, of the digital ON-current detection signal and the digital OFF-current detection signal which are used for determination of the digital data corresponding to the ON-OFF current difference, the digital ON-current detection signal is a signal which is updated every time the inspection signal generating unit supplies the inspection ON signal to a corresponding pixel and a new ON-current detection signal is obtained, and the digital OFF-current detection signal is a signal which is determined and set in advance.

According to another aspect of the present invention, it is preferable that, in the light emitting display device, the set signal is a digital OFF-current detection signal corresponding to an OFF current which is obtained when the inspection OFF signal is supplied to a particular pixel or when the inspection OFF signal is periodically supplied to a corresponding pixel at a predetermined period.

According to another aspect of the present invention, it is preferable that, in the light emitting display device, the current flowing through the electroluminescence element is a cathode current.

According to various aspects of the present invention, an inspection signal is supplied to a pixel and a current, for example, a cathode current, flowing through the element when the inspection signal is supplied is detected, digital data corresponding to the detection signal is stored in a memory, and variation correction for a digital data signal obtained based on a video signal is executed based on the digital data. By setting the number of bits of the digital data stored in the memory to a lower value than the number of bits of the display data signal obtained based on the video signal corresponding to the change characteristic of the current and precision, it is possible to correct the display variation corresponding to characteristics of the pixels which is detected with a high precision, while minimizing the capacity for storage in the memory.

For example, when an ON-display signal and an OFF-display signal are supplied as the inspection signal to a pixel of an inspection row, an ON-current and an OFF-current of the EL element generated in this process are detected, and digital data corresponding to a current difference between an obtained ON-current detection signal and an obtained OFF-current detection signal is stored in a memory unit, by selectively storing the data of the bit positions corresponding to the change range of the ON-current detection signal and the range of the digital data corresponding to the current difference, it is possible to reduce the capacity for storage without losing the precision of the signal to be stored. Alternatively, it is also possible to omit lower significant bits of the ON-current detection signal or the like or lower significant bits of the digital data corresponding to the current difference, according to the precision of the ON-current detection signal or the like.

By measuring the current flowing through the element such as, for example, a cathode current and an anode current in place of measuring the light emission brightness, it is possible to detect a current flowing through the element at a predetermined timing with a simple structure even after the device is shipped.

### BRIEF DESCRIPTION OF THE DRAWINGS

A preferred embodiment of the present invention will be described in detail by reference to the drawings, wherein:

FIG. 1 is an equivalent circuit diagram for explaining an example schematic circuit structure of an EL display device according to a preferred embodiment of the present invention;

FIGS. 2(a) and 2(b) are diagrams for explaining a principle of measurement of characteristic variation of an element driving transistor according to a preferred embodiment of the present invention;

FIG. 3 is a diagram showing an example structure of an EL display device having a display variation correction function according to a preferred embodiment of the present invention;

FIG. 4 is a diagram showing a part of a more specific structure of a driving unit of FIG. 3;

FIG. 5 is a diagram for explaining a deviation of an operation threshold value of an element driving Tr2 and a correction method of the deviation;

FIG. 6 is a diagram for explaining a method of setting example 1 for reducing the number of bits of an ON-OFF current difference signal to be stored in a memory according to a preferred embodiment of the present invention;

FIG. 7 is a diagram showing a part of an example structure of a driving unit which realizes setting example 1 according to a preferred embodiment of the present invention;

FIG. 8 is a diagram for explaining a method of setting example 2 for reducing the number of bits of an ON-OFF current difference signal to be stored in the memory according to a preferred embodiment of the present invention;

FIG. 9 is a diagram showing a part of an example configuration of a driving unit which realizes setting example 4 according to a preferred embodiment of the present invention;

FIG. 10 is a timing chart for explaining driving method 1 according to a preferred embodiment of the present invention;

FIG. 11 is a timing chart for explaining driving method 2 according to a preferred embodiment of the present invention;

FIG. 12 is a diagram for explaining a schematic structure of a panel which executes driving method 3 according to a preferred embodiment of the present invention;

FIG. 13 is a timing chart for explaining driving method 3 according to a preferred embodiment of the present invention;

FIG. 14 is a schematic circuit diagram for explaining an example, different from the example of FIG. 1, of a schematic circuit structure of an EL display device according to a preferred embodiment of the present invention; and

FIG. 15 is a diagram showing an example current detection amplifier according to a preferred embodiment of the present invention.

### DESCRIPTION OF THE PREFERRED EMBODIMENT

A preferred embodiment of the present invention (hereinafter referred to as “embodiment”) will now be described with reference to the drawings.

[Inspection Principle]

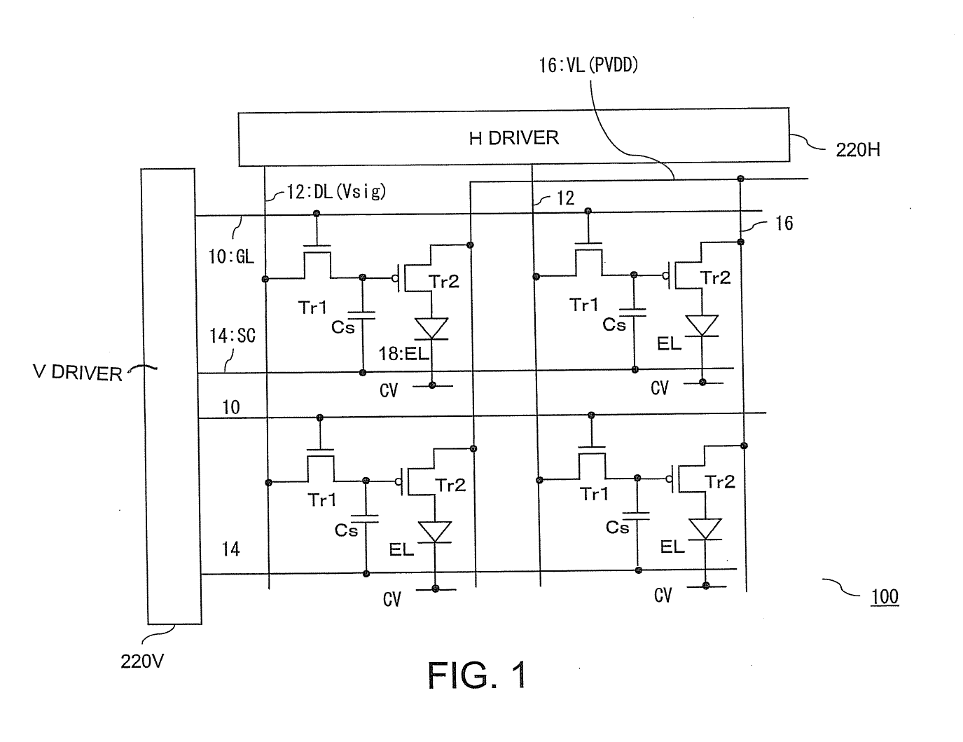

In the embodiment, a light emitting display device is an active matrix organic electroluminescence (EL) display device which uses an EL element as a light emitting element and having a switch in each pixel. FIG. 1 is a diagram exemplifying an equivalent circuit structure of an active matrix EL display device according to the embodiment. A plurality of pixels are arranged in the display section of an EL panel 100 in a matrix form, a selection line (gate line GL) 10 on which a selection signal is sequentially output is formed along a horizontal (H) scan direction (row direction) of the matrix, and a data line 12 (DL) on which a data signal (Vsig) is output and a power supply line 16 (VL) for supplying a drive power supply PVDD to an organic EL element (hereinafter simply referred to as “EL element”) 18 which is an element to be driven are formed along a vertical (V) scan direction (column direction).

Each pixel is provided in a region approximately defined by these lines. Each pixel comprises the EL element 18 as an element to be driven, a selection transistor Tr1 formed by an n-channel TFT (hereinafter referred to as “selection Tr1”), a storage capacitor Cs, and an element driving transistor Tr2 formed by a p-channel TFT (hereinafter referred to as “element driving Tr2”).

The selection Tr1 has a drain connected to the data line 12 which supplies a data voltage (display data signal) Vsig to the pixels along the vertical scan direction, a gate connected to the gate line 10 which selects pixels along one horizontal scan line, and a source connected to a gate of the element driving Tr2.

A source of the element driving Tr2 is connected to the power supply line 16 and a drain of the element driving Tr2 is connected to an anode of the EL element 18. A cathode of the EL element is formed common for the pixels and is connected to a cathode power supply CV.

The EL element 18 has a diode structure and comprises a light emitting element layer between a lower electrode and an upper electrode. The light emitting element layer comprises, for example, at least a light emitting layer having an organic light emitting material, and a single layer structure or a multilayer structure of 2, 3, or 4 or more layers can be employed for the light emitting element layer depending on characteristics of the materials or the like to be used in the light emitting element layer. In the present embodiment, the lower electrode is patterned into an individual shape for each pixel, functions as the anode, and is connected to the element driving Tr2. The upper electrode is common to a plurality of pixels and functions as the cathode.

In an active matrix EL display device having the circuit structure as described above in each pixel, if there is a variation in an operation threshold value Vth of the element driving Tr2, even when a same data signal is supplied to the pixels, the current supplied to the EL element from the drive power supply PVDD would not be the same, possibly resulting in a brightness variation (display variation).

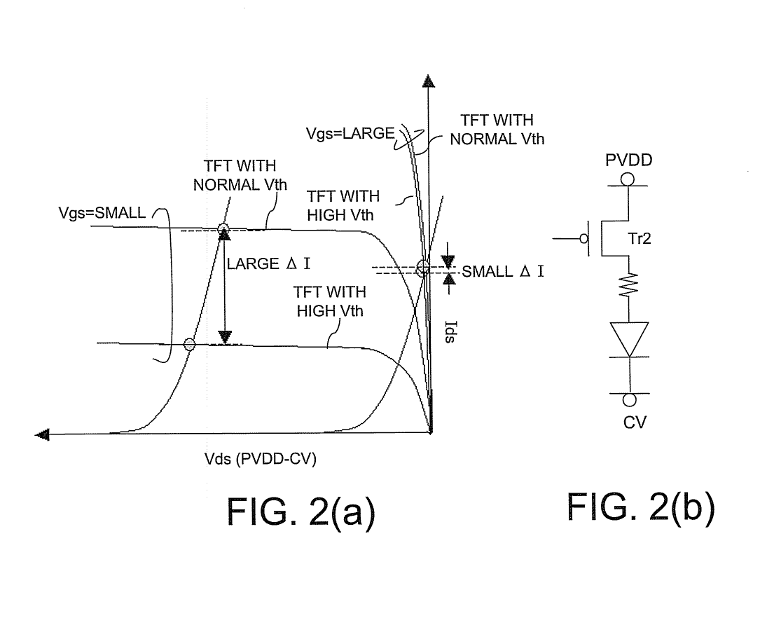

FIG. 2 shows an equivalent circuit of a pixel when a characteristic variation (variation in current supplying characteristic, for example, variation in the operation threshold value Vth) in the element driving Tr2 occurs (FIG. 2(b)) and a Vds−Ids characteristic of the element driving Tr2 and the EL element in this case (FIG. 2(a)). When the operation threshold value Vth of the element driving Tr2 is varied, the circuit can be considered as a circuit in which a resistor having a larger resistance or a smaller resistance than the normal structure is connected on a side of the drain of the element driving Tr2 as shown in FIG. 2(b). Therefore, the characteristic of the current flowing through the EL element (in the present embodiment, cathode current Icv) does not differ from that of the normal pixel, but the current actually flowing through the EL element varies according to the characteristic variation of the element driving Tr2.

When the applied voltage to the element driving Tr2 satisfies a condition of Vgs−Vth<Vds, the element driving Tr2 operates in the saturation region. As shown in FIG. 2(a), in a pixel having a higher operation threshold value Vth of the element driving Tr2 than that of a normal pixel, the current Ids between the drain and the source of the transistor is smaller compared to the normal transistor, and an amount of supplied current to the EL element, that is, the current flowing through the EL element is smaller than that of the normal pixel (a large ΔI). As a result, the emission brightness of the pixel becomes lower than that of the normal pixel, resulting in a display variation.

In a pixel having a lower operation threshold value Vth of the element driving Tr2 than that of the normal pixel, on the other hand, the current Ids between the drain and the source of the transistor is larger compared to the normal transistor, the current flowing through the EL element is greater than that of the normal pixel, and the emission brightness becomes higher.

When the applied voltage to the element driving Tr2 satisfies a condition of Vgs−Vth>Vds, the element driving Tr2 operates in the linear region. Because a difference in the Vds−Ids characteristic is small in the linear region between an element driving Tr2 having a higher threshold value Vth and an element driving Tr2 having a lower threshold value Vth, the difference in the amount of supplied current to the EL element (ΔI) is also small. Because of this, the EL elements show approximately similar emission brightness regardless of the presence or absence of characteristic variation of the element driving Tr2, and it is difficult to detect the display variation caused by the characteristic variation in the linear region. However, by operating the element driving Tr2 in the saturation region as described above, it is possible to detect the display variation caused by the characteristic variation of the element driving Tr2.

By correcting the data signal to be supplied to the pixels based on the detected current value, it is possible to reliably correct the display variation. For example, when the absolute value |Vth| of the threshold value of the element driving Tr2 is lower than normal, the emission brightness of the EL element when a reference data signal is supplied would be higher than normal. Therefore, in this case, the absolute value |Vsig| of the data signal can be reduced according to a deviation of the absolute value |Vth| of the threshold value from the reference, so that the brightness variation is corrected. When, on the other hand, the absolute value |Vth| of the threshold value of the element driving Tr2 is higher than normal, the absolute value |Vsig| of the data signal can be enlarged according to a deviation of the absolute value |Vth| of the threshold value from the reference, so that the brightness variation is corrected.

In the above-described pixel circuit, a p-channel TFT is employed as the element driving transistor, but the present invention is not limited to such a configuration, and, alternatively, an n-channel TFT may be employed. In addition, in the above-described pixel circuit, a structure is exemplified having two transistors in each pixel including a selection transistor and a driving transistor as transistors in a pixel. However, the present invention is not limited to a structure with two transistors or to the above-described circuit structure.

According to such a principle, by supplying the inspection signal as described above to the pixels and obtaining a cathode current of the EL element, it is possible to detect brightness variation of the EL elements caused by the characteristic variation of the element driving Trs of the pixels. The detected cathode current is converted to digital data as a current detection signal and stored in a memory. The digital data is used to generate correction data for correction of the variation of the threshold value. The generated correction data is further used for two-dimensional variation correction for a display data signal generated based on the video signal in order to be supplied to the pixel.

In the present embodiment, the number of bits of the digital data to be stored in the memory is reduced compared to the number of bits of the digital display data signal obtained by executing the two-dimensional variation correction using the correction data according to characteristics such as a change allowance range, a change expectation range, precision, or the like of the cathode current.

The current detection (variation detection) and the correction are desirably executed also prior to shipping of the display device, from the viewpoint of determination of a defect device, and desirably executed after shipping, as such a configuration is effective in executing correction corresponding to a change with elapse of time. For example, it is possible to execute the process when the power supply of the display device is started up after the shipping or during a normal operation, to inspect variation without giving an unnatural feeling on the display itself and to apply an optimum correction at all times.

When the inspection is to be executed during normal operation, the inspection may be executed during a blanking period of the video signal. During the blanking period, a predetermined row of the display section is selected as an inspection row, an inspection signal is supplied to the corresponding pixel, and a cathode current Icv flowing from the cathode electrode of the EL element of the pixel to the cathode terminal is detected. The blanking period is a vertical blanking period or a horizontal blanking period. As a driving method, as will be described in detail later, the following methods may be employed.

(Driving Method 1)

This method is a configuration where the cathode electrode is a common electrode common to all pixels and the cathode current is detected during a horizontal blanking period.

For an EL panel 100 having a matrix of y rows and x columns, one inspection row (nth row) is selected during one horizontal blanking period, an inspection signal is supplied to a pixel of a predetermined column (kth column), and a cathode current is detected. By repeating this operation while sequentially changing the selected row, cathode currents for all pixels of the kth column in one frame (one vertical (V) scan) period are detected. By executing this process on all columns, the detection process for all pixels of the EL panel 100 is completed. When the EL panel 100 has a size of the VGA type, pixels of 480 rows×640 columns are present, and, with the above-described method and a unit frame of 60 Hz, the cathode current can be detected for all pixels in a total time of approximately 10.7 seconds (= 1/60 seconds*640 columns). The number of bits of the detection signal to be stored in a memory 370 is reduced compared to the number of bits N of the display data signal by any of the methods of setting examples 1-4 to be described later.

(Driving Method 2)

This method is a configuration where the cathode electrode is common to all pixels and the cathode current is detected during a vertical blanking period.

An inspection signal is sequentially supplied to all pixels belonging to a predetermined inspection row (nth row) during a vertical blanking period, and a cathode current is detected. By repeating this process for all rows while changing the inspection row for each vertical blanking period, the cathode currents for all pixels are obtained. In this driving method, in the case of the VGA panel similar to the above, the cathode current for all pixels can be detected in a total time of approximately 8 seconds (= 1/60 seconds*480 rows). The reduction of the storage capacity of the memory 370 is similar to that in the driving method 1.

(Driving Method 3)

This method is a configuration where the cathode electrode is divided for each column and the cathode current is detected during a vertical blanking period.

An inspection signal is supplied to all pixels of a predetermined inspection row (nth row) during a vertical blanking period, and a cathode current in each column is detected. By repeating this process for all rows while changing the inspection row for each vertical blanking period, the cathode currents of all pixels are obtained. In this method, in the case of the VGA panel similar to the above, the cathode currents for all pixels can be detected in a total time of approximately 8 seconds (= 1/60 seconds*480 rows).

When the driving capability (driving speed) of the driver portion is sufficient, it is possible to supply an inspection signal to all pixels belonging to a predetermined row and detect the current from the cathode electrode of each column during the horizontal blanking period. In this case, the cathode current for all pixels can be measured in one frame period.

Similar to the driving methods 1 and 2, in the driving method 3 also, the memory capacity is reduced by the methods such as the setting examples 1-4 to be described later.

[Example Device Structure]

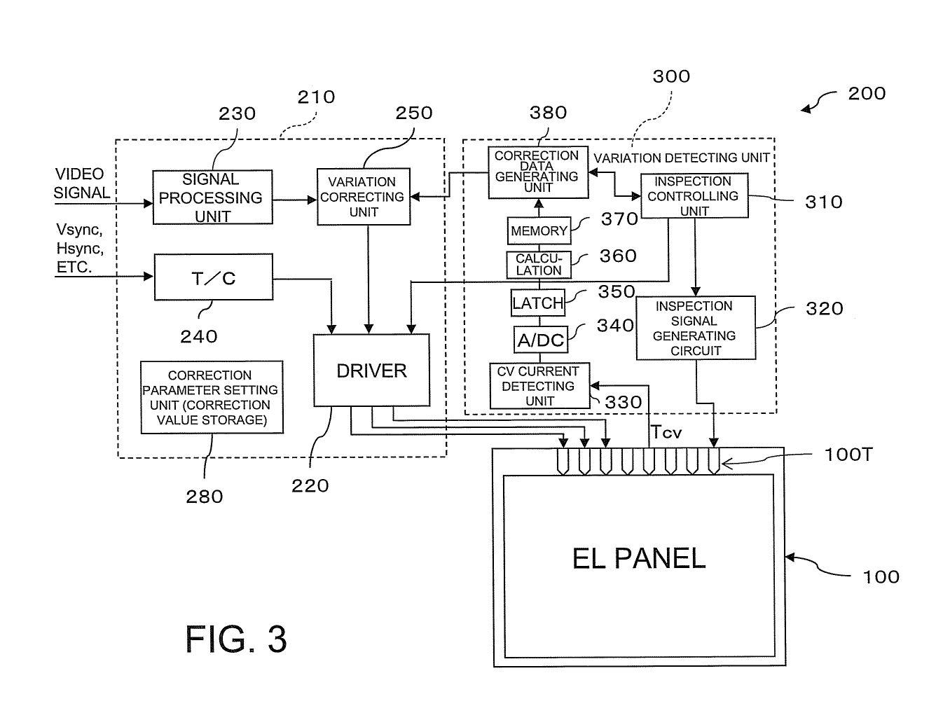

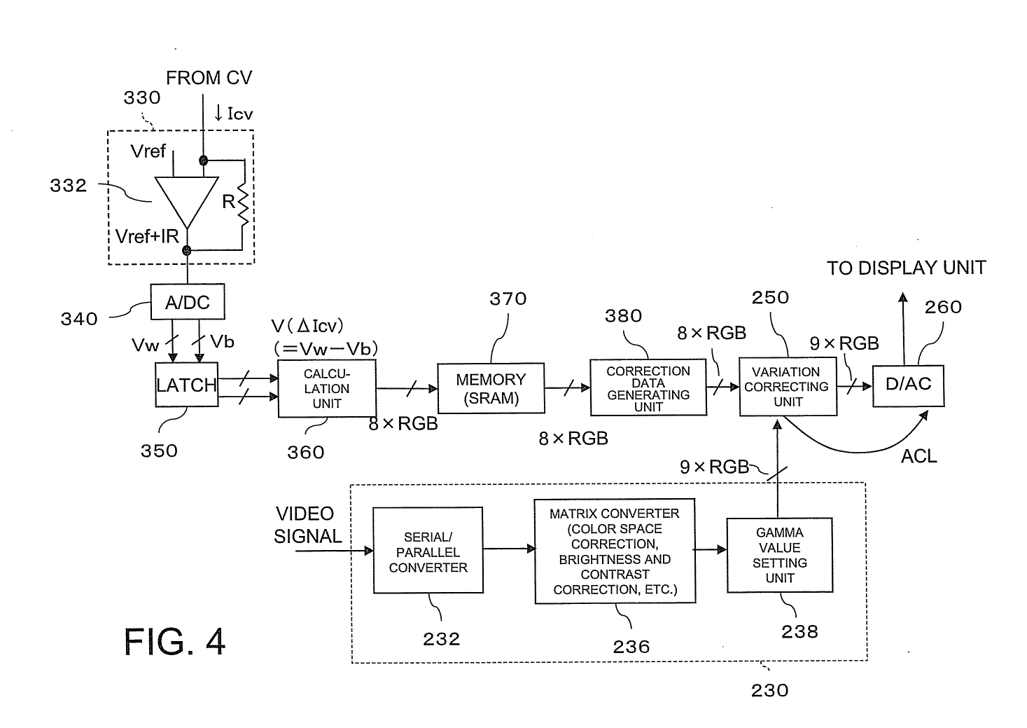

Next, an example structure of the electroluminescence display device having the variation correction function according to the present embodiment will be described with reference to FIGS. 3 and 4. FIG. 3 shows an example of an overall structure of an electroluminescence display device. The display device comprises an EL panel 100 on which the display section having the pixels as described above are formed and a driving unit 200 which controls display and operation on the display section. The driving unit 200 primarily comprises a display controlling unit 210 and a variation detecting unit 300.

The display controlling unit 210 comprises a signal processing unit 230, a variation correcting unit 250, a timing signal generating (T/C) unit 240, a driver 220, etc.

The signal processing unit 230 generates a display data signal suitable for a display of a color video signal from the outside on the EL panel 100. The timing signal generating unit 240 generates various timing signals necessary in the display section such as an H clock CKH, a V clock CKV, a horizontal start signal STH, and a vertical start signal STV, based on a dot clock (DOTCLK), synchronization signals (such as Hsync and Vsync), etc. supplied from the outside. The variation correcting unit 250 corrects the video signal according to the characteristic of the EL panel to be driven, using the correction data obtained in the variation detecting unit 300.

The driver 220 generates a signal for driving the EL panel 100 in the H direction and the V direction based on various timing signals obtained from the timing signal generating unit 240 and supplies the signal to the pixel, and supplies a corrected video signal supplied from the variation correcting unit 250 to each corresponding pixel as a display data signal (Vsig). The driver 220 comprises, as shown in FIG. 1, an H driver 220H which controls driving along the H (row) direction of the display section and a V driver 220V which controls driving along the V (column) direction. As shown in FIG. 1, the H driver 220H and the V driver 220V may be built on the panel substrate at a periphery of a display region of the EL panel 100 similar to the pixel circuit of FIG. 1, or may be constructed using an integrated circuit (IC) which is integral with or separate from the driving unit 200 of FIG. 3, separately from the EL panel 100.

The variation detecting unit 300 executes an operation to detect a display variation at a predetermined timing, for example, in the blanking period, under a normal usage environment of the EL panel 100 and obtaining the correction value.

In the example structure of FIG. 3, the variation detecting unit 300 comprises an inspection controlling unit 310 which controls the variation inspection, an inspection signal generating circuit 320 which generates an inspection signal and supplies the inspection signal to the pixel of the inspection row of the EL panel, and a cathode current detecting unit 330 which detects a cathode current obtained from the cathode electrode when the inspection signal is supplied. The variation detecting unit 300 further comprises an analog-to-digital (A/D) converter 340, a latch circuit 350, a calculation unit 360, a memory 370, a correction data generating unit 380, etc. The A/D converter 340 converts the detected cathode current (cathode current detection signal) into digital data, and the latch circuit 350 temporarily stores the obtained digital data. The calculation unit 360 calculates a predetermined calculation value (for example, an ON-OFF current difference) based on the digital current detection signal stored in the latch circuit 350, and the memory 370 stores the calculation result. The correction data generating unit 380 generates correction data based on the calculation value stored in the memory 370.

A control signal generating circuit (not shown) for generation of a selection signal necessary for selecting a pixel of an inspection row and for inspecting the pixel during the inspection and for potential control of a predetermined line to be described later may be incorporated into the driver 220 and executed according to a control of the inspection controlling unit 310.

The structure for generating the control signal may be executed by a dedicated circuit for generating the inspection control signal or may be executed by the inspection controlling unit 310.

FIG. 4 shows an example of a more concrete structure of the driving unit 200 of FIG. 3. The cathode current detecting unit 330 comprises a current detection amplifier 332, and, in the example configuration of FIG. 4, comprises a resistor R between an output of the amplifier and an input side of the current, and obtains a cathode current Icv obtained from the cathode electrode terminal Tcv of the EL panel as a current detection signal (voltage data) represented by [Vref+IR], based on a voltage [IR] generated by the cathode current Icv flowing through the resistor R and the reference voltage Vref. The A/D converter 340 converts the current detection signal obtained by the current detection amplifier 332 into a digital signal of a predetermined number of bits, the obtained digital current detection signal is temporarily stored in the latch circuit 350 and supplied to the calculation unit 360 at a predetermined timing, and the calculation result is supplied to and stored in the memory 370.

By supplying an inspection ON display signal which sets the emission of the EL element to the emission level as the inspection signal, in principle, the display unevenness corresponding to the threshold value variation of the element driving Tr2 can be detected. However, by employing a configuration in which the above-described inspection ON display signal and an inspection OFF display signal which sets the EL element to a non-emission level are supplied to the pixel of the inspection row as the inspection signal, an ON-cathode current when the inspection ON display signal is applied and an OFF-cathode current when the inspection OFF display signal is applied are detected, and a difference ΔIcv between these cathode currents are determined, it is possible to increase the speed of the inspection and improve precision of the inspection.

The increase in the speed and the improvement in precision of the inspection are enabled because the OFF-cathode current Icv_{off} is measured and the ON-cathode current Icvₒₙ for the ON display signal can be grasped relative with reference to the Icv_{off}, and, consequently, it is not necessary to precisely determine the absolute value of the ON-cathode current Icvₒₙ and to separately measure the OFF-cathode current Icv_{off} as a reference. In other words, with the use of the difference between the ON-cathode current and the OFF-cathode current (cathode current difference or ON-OFF current difference), it is possible to cancel, from the cathode current difference, the influence of the characteristic variation of the current detection amplifier 332 or the like, and the reference value for determining the absolute value of the ON-cathode current value is not necessary. More specifically, the current detection amplifier 332 detects the ON-cathode current as Vref+Icvₒₙ*R (ON-current detection signal) and detects the OFF-cathode current as Vref+Icv_{off}*R (OFF-current detection signal), the A/D converter 340 converts the signals into digital data, and the calculation unit 360 calculates the difference between the two digital data, so that a value of (Icvₒₙ−Icv_{off})*R is determined. With this process, V(ΔIcv)=V(Icvₒₙ)−V(Icv_{off}) is obtained as data (ON-OFF current difference signal) corresponding to the ON-OFF current difference (ON-OFF cathode current difference).

As described above with reference to the (Driving Method 1)-(Driving Method 3), the memory 370 stores digital data (ON-OFF current difference signal) corresponding to the ON-OFF current difference as the cathode current detection signal for all pixels in approximately 10 seconds, for example, and stores the data at least until new cathode currents are detected for all pixels. As the memory 370, a volatile memory (such as SRAM) in which data can be written and read at a high speed may be used. Although not shown, a non-volatile memory such as EEPROM which can store data even when the power supply of the device is switched OFF and which can be rewritten may additionally be used as a secondary memory. If the secondary memory is to be additionally used, before the power supply of the device is switched OFF, the ON-OFF current difference signal stored in the volatile memory is saved on the secondary memory in advance. When the power supply of the device is started up, the ON-OFF current difference signal stored in the secondary memory may be used so that the two-dimensional variation correction can be executed immediately after the power supply of the device is started up.

The correction data generating unit 380 constantly reads the current difference detection signal for each pixel accumulated in the memory 370, and generates, based on the read current difference detection signal, correction data for correcting the display variation caused by the characteristic variation of the element driving Tr2 of the pixel for a video signal. Next, determination of the correction data and the method of the two-dimensional variation correction will be described.

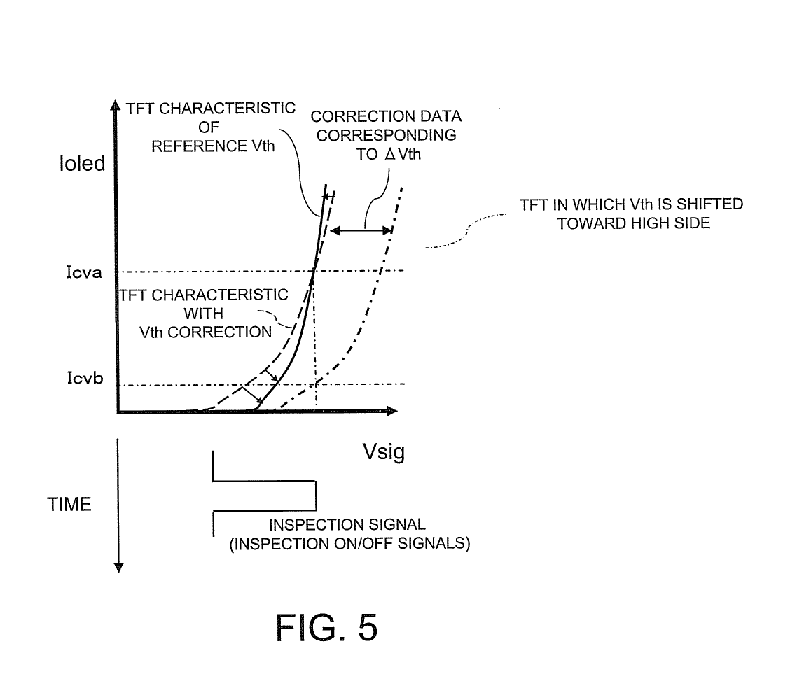

First, when a same inspection signal which sets the EL element to an emission state is applied, if the threshold value Vth of the element driving Tr2 of the pixel to be measured is shifted to a higher voltage side than the threshold value Vth of the normal element driving Tr2 (a dot-and-chain line in the figure), the obtained cathode current is Icvb in the shifted pixel whereas the obtained cathode current is Icva in the normal pixel (refer to FIG. 5).

The correction data generating unit 380 determines, when the operation threshold value Vth of the element driving Tr2 is deviated from the normal TFT as shown in FIG. 5, correction data which compensates the deviation of the operation threshold value Vth based on the cathode current detection data. Conceptually, with the correction data, the voltage of the data signal to be supplied to the pixel is shifted according to the amount of deviation of the operation threshold value Vth as in a characteristic shown by a dotted line in FIG. 5.

An example of a method of generating the correction data for shifting the voltage of the data signal will be described below. First, the deviation of the operation threshold value of the pixel from the reference can be determined through the following Equation (1).

$$V ( Δ Icv ) = V ( Δ Icvref ) \times {( \frac{Vsigon - Vth ( i )}{Vsigon} )}^{γ} \qquad ( 1 )$$

In Equation (1), Vth(i), V(Icv), Vsigon, and γ are defined as follows.
Vth(i): Deviation of operation threshold value of pixel to be inspected.
V(ΔIcv): ON-OFF current difference (voltage data) of the pixel to be inspected.
V(ΔIcvref): Reference ON-OFF current difference (voltage data).
Vsigon: Grayscale level of inspection ON display signal.
γ: Emission efficiency characteristic of display panel (constant value).

If the grayscale level of the inspection ON display signal [Vsigon] is represented with 8 bits and is set to 240 (0-255), for example, the deviation of the operation threshold value Vth(i) of the pixel from the reference can be determined from Equation (1), based on the grayscale level of 240, the ON-OFF current difference [V(ΔIcv)] of the pixel to be inspected, the reference ON-OFF current difference [V(ΔIcvref)], and a constant emission efficiency characteristic y. For example, for pixels A-E, the following amounts of deviation of the threshold value Vth(i) from the reference may be obtained.

### Vth(A)=0

### Vth(B)=13.4

### Vth(C)=17.0

### Vth(D)=3.2

### Vth(E)=20.7

In this example configuration, the deviation of the threshold value Vth of the pixel E is the largest. When a data signal of the same grayscale level is supplied to the pixels, the pixel E would emit light with a minimum brightness in the display section. On the other hand, there is a limit to the maximum value of the data signal which can be supplied to the pixels. Therefore, the maximum value Vsigₘₐₓ of the data signal is determined with reference to the pixel E having the Vth(i)ₘₐₓ. In other words, among the obtained Vth(i) of the pixels, a maximum value Vth(i)ₘₐₓ is determined, and differences ΔVth(i) of the Vth of other pixels from the Vth(i)ₘₐₓ are obtained. In addition, a maximum value of the data signal Vsigₘₐₓ(i) to be supplied to the pixel is determined by subtracting the obtained delta Vth(i) from the Vsigₘₐₓ [Vsigₘₐₓ−ΔVth(i)], and supplied to the variation correcting unit 250 as initial correction data RSFT(init) reflecting the correction value of Equation (2) to be described later.

The correction data of each pixel generated by the correction data generating unit 380 in this manner may be stored in the correction value storage 280 or the like, for example, shown in FIG. 3. The correction data is desirably stored until the correction data for all pixels are next completed.

The variation correcting unit 250 uses the stored correction data until new correction data is obtained, and executes a variation correction for each pixel on the video signal supplied from the signal processing unit 230 (two-dimensional display unevenness correction). Alternatively, it is also desirable that, at a timing necessary for correction calculation in the variation correcting unit 250 (that is, matching the timing of the video signal), the correction data generating unit 380 generates the correction data and supplies the correction data to the variation correcting unit 250. In this case, only Vsigₘₐₓ(i) is stored in the correction value storage 280 as described above, and the correction data generating unit 380 reads the cathode current detection data (digital data) for a necessary pixel address from the memory 370, generates the correction data using the data and Vsigₘₐₓ(i), and supplies the correction data to the variation correcting unit 250.

The signal processing unit 230 is a signal processing circuit which converts the color video signal from the outside into a display signal suited for display on the EL panel 100, and has, for example, a structure shown in FIG. 4. A serial/parallel converter 232 converts the video signal supplied from the outside into parallel data, and the obtained parallel video signal is supplied to a matrix converter 236. At the matrix converter 236, if the video signal supplied from the outside is in YUV format, an offset process according to a color tone displayed by the EL panel is executed. Y is a brightness signal, U is a difference between the brightness signal and a blue color component, and V is a difference between the brightness signal and a red color component. YUV format represents a color with these three information. The matrix converter 236 also executes a conversion process such as thinning of the parallel video signal into a format suited for the EL panel 100. In addition, the matrix converter 236 executes a color space correction, a brightness and contrast correction, etc. A γ value setting unit 238 sets a γ value (γ correction) corresponding to the EL panel 100 on the video signal from the matrix converter 236, and the video signal after the γ correction is supplied to the variation correcting unit 250.

In the variation correcting unit 250, for example, a two-dimensional display unevenness correction is executed using the following Equation (2).

$$R\_SFT ( 0 ) = \frac{\frac{ADJ\_SFT}{16} \times ( 512 - Rin ) + Rin}{512} \times RSFT ( init ) \qquad ( 2 )$$

In Equation (2), RSFT(init) is initial correction data reflecting the correction value determined by the correction data generating unit 380 (value which also reflects correction data for each pixel prior to the shipping from the factory if such correction data exists), Rin is an input video signal supplied from the signal processing unit 230 which is 9-bit data in this example configuration and has a value of one of 0-511, ADJ_SFT is a correction value adjusting (weighting) parameter, and R_SFT is display data after the two-dimensional display unevenness correction.

As shown in FIG. 5, when a deviation occurs in the operation threshold value Vth of the element driving Tr2, a slope β of the characteristic curve of the TFT differs from the slope of the characteristic curve of the normal TFT. Therefore, an accurate grayscale representation cannot be achieved by merely shifting the display data signal by an amount of deviation of Vth. Thus, in the variation correcting unit 250, an optimum correction is applied according to the value of the actual video signal (brightness level) using Equation (2) and in consideration of the slope β, that is, the weighting parameter of Equation (2) described above, so that the signal is adjusted to allow a cathode current corresponding to the normal TFT characteristic flows through the EL element. With such a correction, it is possible to reliably prevent whitening on a lower grayscale side (deviation to the high grayscale side) caused by a difference in the slope of the TFT characteristic with only the simple shift correction of ΔVth.

The video signal to which the two-dimensional unevenness correction is applied as described above (display data signal) is supplied to a digital-to-analog (DA) converter 260, and is converted to an analog display data signal to be supplied to the pixels. The analog display data signal is data to be output on the corresponding data line 12 of the display section, is output to a video line provided on the panel 100, and is supplied to the corresponding data line 12 according to a control of the V driver 220V. The variation correcting unit 250 estimates a power consumption based on the data signal supplied from the signal processing unit 230, generates an ACL signal for optimally controlling a peak current of the EL panel 100, and supplies the ACL signal to the D/A converter 260. With this structure, generation of a current with an excessive consumption is inhibited in the panel 100.

[Control of Number of Bits of Data Stored in Memory]

Next, a number of bits of digital data stored in the memory 370 will be described. In the example shown in FIG. 4, a digital display data signal generated from the video signal, to which the two-dimensional variation correction is applied, and which is supplied to the D/A converter 260 has a number of bits of N (here, 9 bits) for each of R, G, and B. The number of bits of the digital data for each pixel stored in the memory 370 is set to (N−1) or lower (here, 8 bits). As the number of bits of (N−1) of the digital data stored in the memory 370, the following setting examples may be employed.

### Setting Example 1

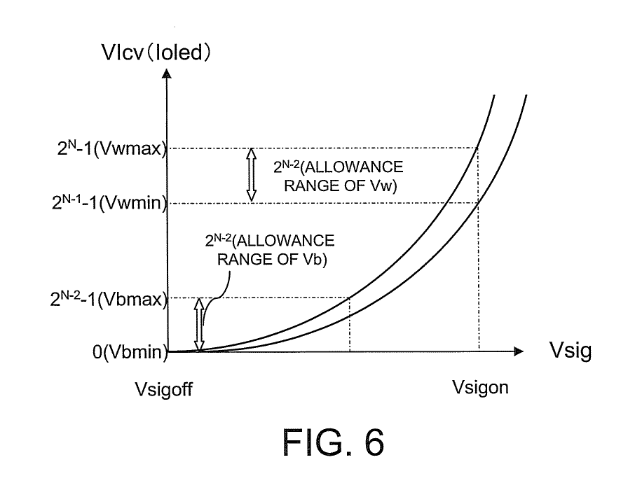

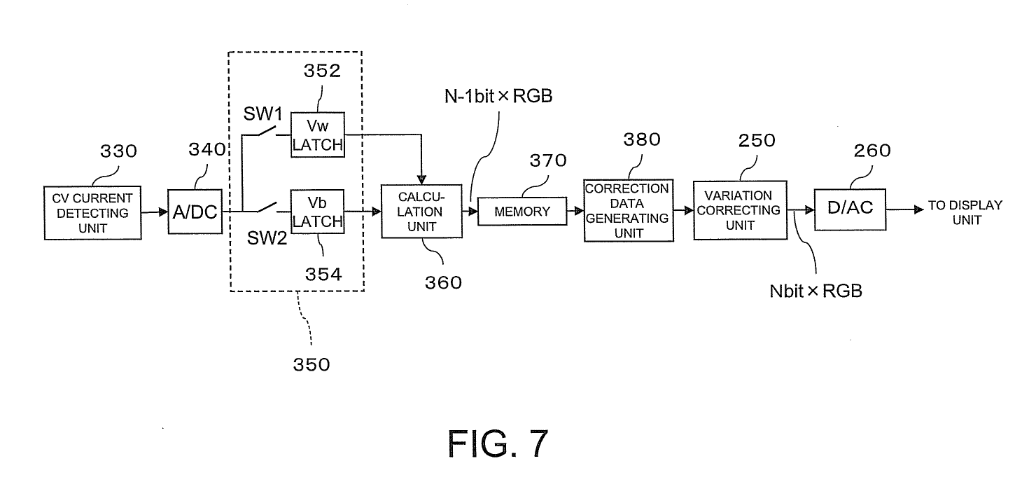

Insetting example 1, an inspection ON signal and an inspection OFF signal are supplied as the inspection signal, the number of bits of the ON-OFF current difference obtained by the calculation unit 360 is set to (N−1), and the ON-OFF current difference signal is stored in the memory 370. FIG. 6 shows a characteristic of the cathode current (as cathode current detection signal VIcv) obtained with respect to the data signal Vsig supplied to the pixels, and the setting example 1 considers the characteristic of FIG. 6. FIG. 7 shows important portions of the driving circuit 200 for executing processes related to the setting example 1.

When the operation threshold value Vth of the element driving Tr2 which supplies a drive current to the EL element 18 varies, the values of the obtained cathode current Icv (Ioled) also differ. As described above, in the present embodiment, the variation is corrected, but, when the variation exceeds an allowance range, the variation cannot be corrected even with a maximum shift of the display data signal. In other words, the allowance range of the variation can be considered as the change range (change allowance range) of the ON-current detection signal and the OFF-current detection signal.

The setting example 1 determines the number of bits of the ON-OFF current difference signal to be stored in the memory 370 in consideration of the change range of the ON-current detection signal and the OFF-current detection signal. In other words, according to the range which can be taken by the ON-OFF current difference signal, the data of bit positions of (N−1)th bit or lower, other than the most significant bit (MSB), of the N bits, which may change is stored as the ON-OFF current difference signal.

In the illustrated configuration of FIG. 6, each of the change allowance range of the ON-current detection signal (emission (white) detection signal: Vw) obtained when the inspection ON signal is supplied and the change allowance range of the OFF-current detection signal (non-emission (black) detection signal: Vb) obtained when the inspection OFF signal is supplied is 2^{(N-2)} within (2^{N}−1) respectively. In this case, Vw is always greater than Vb because of the current-voltage characteristic of the EL element, the ON-OFF current difference signal V(ΔIcv) (=Vw−Vb) changes in a range of 2^{(N-1)}˜(2^{N}−1). In other words, the change range of Vw-Vb is only the lower (N−1) bits among the N bits (Vw−Vb−2^{(N-1)}=0˜2^{(N-1)}−1). That is, an accurate value can be obtained by applying a subtraction process on the lower (N−1) bits of the ON-current detection signal and the OFF-current detection signal.

When the A/D converter 340 converts the ON-current detection signal and the-OFF current detection signal supplied from the current detection amplifier 332 into corresponding digital data of N bits, the A/D converter 340 outputs only the (N−1) lower bits, among the N bits, which changes as the corresponding signals Vw and Vb.

The lower (N−1) bit signals Vw and Vb of the ON-current detection signal and the-OFF current detection signal which are output from the A/D converter 340 are supplied to corresponding Vw latch 352 and Vb latch 354 through switches SW1 and SW2 which is controlled to be switched at a timing matching the supply timing of the data, and are maintained until new data is next supplied.

The calculation unit 360 calculates a difference between the digital ON-current detection signal Vw and the digital OFF-current detection signal Vb of lower (N−1) bits, and obtains a digital ON-OFF current difference signal of (N−1) bits. The memory 370 stores the digital ON-OFF current difference signal of (N−1) bits, and the correction data generating unit 370 generates the correction data through the above-described calculation using the digital ON-OFF current difference signal of (N−1) bits.

The correction data to be generated may be represented with (N−1) bits, or, because the value of the most significant bit of the ON-OFF current difference signal which is read from the memory 370 is known (fixed), the data of the most significant bit of the read ON-OFF current difference signal may be automatically attached and the ON-OFF current difference signal of N bits may be supplied to the correction data generating unit 370. Therefore, in the variation correcting unit 250, for digital display data signal of N bits generated based on the video signal and supplied corresponding to the display content to each pixel, correction data of (N−1) bits or correction data of N bits is used and the two-dimensional variation correction is executed through the above-described calculation.

As described, by reducing the number of bits of the ON-OFF current difference signal to be stored in the memory 370 according to the change ranges of the ON-current detection signal and the OFF-current detection signal as in the setting example 1, it is possible to reduce the amount of stored data without losing the precision of the ON-OFF current difference signal. When the change ranges of the ON-current detection signal and the OFF-current detection signal are smaller than 2^{(N-2)}, the number of bits to be stored in the memory 370 can be set to less than (N−1).

Alternatively, it is also possible to employ a configuration in which the A/D converter 340 outputs the ON-current detection signal of N bits and the OFF-current detection signal of N bits, the latch circuit 350 stores the N-bit signals, the calculation unit 360 omits the most significant bit among the N bits of the ON-OFF current difference signal to determine the lower (N−1) bits which may change, and the memory 370 stores the obtained ON-OFF current difference signal of (N−1) bits.

### Setting Example 2

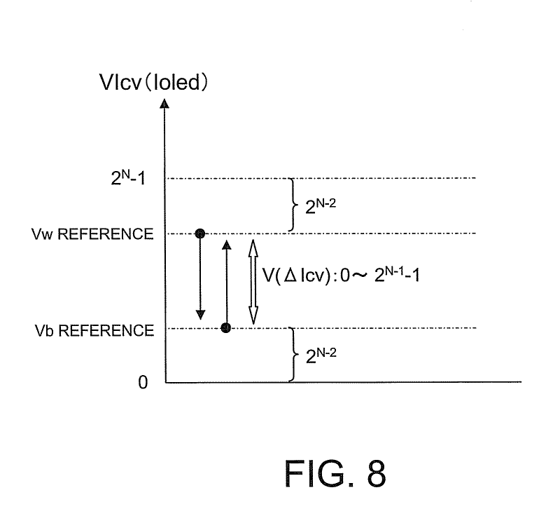

In the setting example 2, only the lower significant bits which may change among the N bits of the display data signal are stored in the memory 370 according to a change range of the ON-OFF current difference signal. When the reference value of the ON-current detection signal Vw (a maximum possible value) and the reference value of the OFF-current detection signal Vb (a minimum possible value) are set as shown in FIG. 8 with respect to the maximum value (2^{N}−1) of the display data signal, because Vw>Vb is always true, the possible range of the ON-OFF current difference signal (change allowance range) is 0˜(2^{(N-1)}−1). In other words, when the reference value of the ON-current detection signal Vw is less than the maximum value (2^{N}−1) of the display data signal by 2^{(N-2)} and the reference value of the OFF-current detection signal is greater than 0 by 2^{(N-2)}, the ON-OFF current difference signal which is a difference between the ON-current detection signal Vw and the OFF-current detection signal Vb can be represented with (N−1) bits.

In the setting example 2, in consideration of such a change range of the ON-OFF current difference signal, a digital ON-OFF current difference signal having a number of bits of (N−1) or less is stored in the memory 370. When reference value of Vw is lower than that of FIG. 8 and the reference value of Vb is higher than that of FIG. 8 in the setting example, the ON-OFF current difference signal may have only the (N−2)th and lower bits among the N bits changing, and, in this case, the lower bits of (N−2)th bit or lower which change may be stored in the ON-OFF current difference signal in the memory 370, resulting in a further reduction of the storage capacity.

A/D converter 340 outputs the ON-current detection signal of N bits and the OFF-current detection signal of N bits, the calculation unit 360 outputs the ON-OFF current difference signal of (N−1)th bit or lower among the N bits as the calculation result, and the memory 370 can store the ON-OFF current difference signal. Alternatively, it is also possible to employ a configuration in which the ON-current detection signal and the OFF-current detection signal of (N−1)th bit or lower among the N bits are output from the A/D converter 340, and an ON-OFF current difference signal of (N−1) bits is determined in the calculation unit 360 and stored in the memory 370.

### Setting Example 3

In setting example 3, the number of bits of the ON-OFF current difference signal to be stored in the memory 370 is reduced according to the precision of the ON-current detection signal Vw and the OFF-current detection signal Vb. For example, when the precision of the ON-current detection signal Vw and the OFF-current detection signal Vb is ½, the least significant bit (LSB) can be ignored. Therefore, in this case, the A/D converter omits the least significant bit of the obtained ON-current detection signal and the OFF-current detection signal and outputs only the upper bits not including the least significant bit for the number N of bits of the digital display data signal obtained from the video signal, as the ON-current detection signal of (N−1) bits and the OFF-current detection signal of (N−1) bits. Alternatively, it is also possible to employ, as the A/D converter 340, an (N−1)-bit converter which converts the supplied analog data (ON-cathode current and OFF-cathode current) into digital data of (N−1) bits (ON-current detection signal and OFF-current detection signal).

### Setting Example 4

In setting example 4, in consideration of the fact that the change range of the OFF-current detection signal is narrower than that of the ON-current detection signal, that is, the fact that the change of the value of the OFF-current detection signal is smaller compared to the ON-current detection signal, an updating frequency of the OFF-current detection signal is set to be longer than that of the ON-current detection signal or a fixed value is used as the OFF-current detection signal. The fixed value is determined in consideration of the characteristic of the current detection amplifier 332 used in the cathode current detecting unit 330.

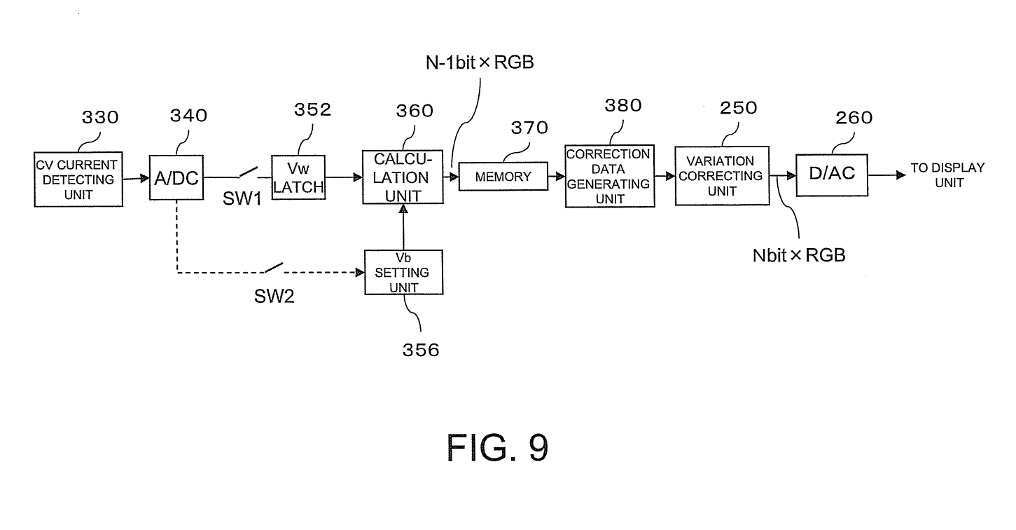

FIG. 9 shows an example structure of a driving circuit which executes an operation of the setting example 4. This structure differs from that of FIG. 7 in the latch circuit 350. The latch circuit 352 which stores the ON-current detection signal Vw is identical to that of FIG. 7, but the OFF-current detection signal which is obtained before or after the ON-current detection signal is not set in the Vb setting unit 356 every time the OFF-current detection signal is obtained. The timing in which the OFF-current detection signal Vb is set may be executed by, for example, controlling an opening timing of the switch SW2 provided between the Vb setting unit 356 and the A/D converter 340 so that the OFF-current detection signal Vb is set every time the inspection signals are supplied to a predetermined plurality of pixels. More specifically, the supply frequency may be set such as once every predetermined rows or once every predetermined columns, according to an estimated length in which the characteristic change of the OFF-current detection signal becomes significant.

Alternatively, it is also possible, for example, prior to shipping of the display device, to determine the OFF-current detection signal in advance and set the OFF-current detection signal in the Vb setting unit 356 as a fixed value. However, because the OFF-current detection signal is slightly affected by the change with elapse of time of the element driving Tr2, the OFF-current detection signal may be periodically updated at a predetermined period (for example, every time power supply of the device is started up, every day, every month, etc.), which is advantageous from the viewpoint of maintaining the variation correction precision.

In the configuration in which the cathode electrode is divided for each column and current is detected using a current detecting unit 330 common to a plurality of columns, both the ON-current detection characteristic and the OFF-current detection characteristic may vary for each current detection amplifier 332. Therefore, it is desirable that, even in the case where the OFF-current detection signal is periodically updated and an initial value is to be fixedly set, the OFF-current detection signal obtained for each corresponding current detection amplifier 332 be set to the Vb setting unit 356 as described above.

[Driving Method]

Next, a driving method of a display device which executes an inspection of the cathode current will be described. In the below description of the driving methods, a configuration is described exemplifying a high speed inspection method in which the inspection ON display signal (EL emission) and inspection OFF display signal (EL non-emission) are sequentially applied as the inspection display signal Vsig to the pixels of the inspection row. The order of the inspection ON display signal and the inspection OFF display signal is not particularly limited, and the order in the below-described configuration is set to the order of OFF and ON.

(Driving Method 1)

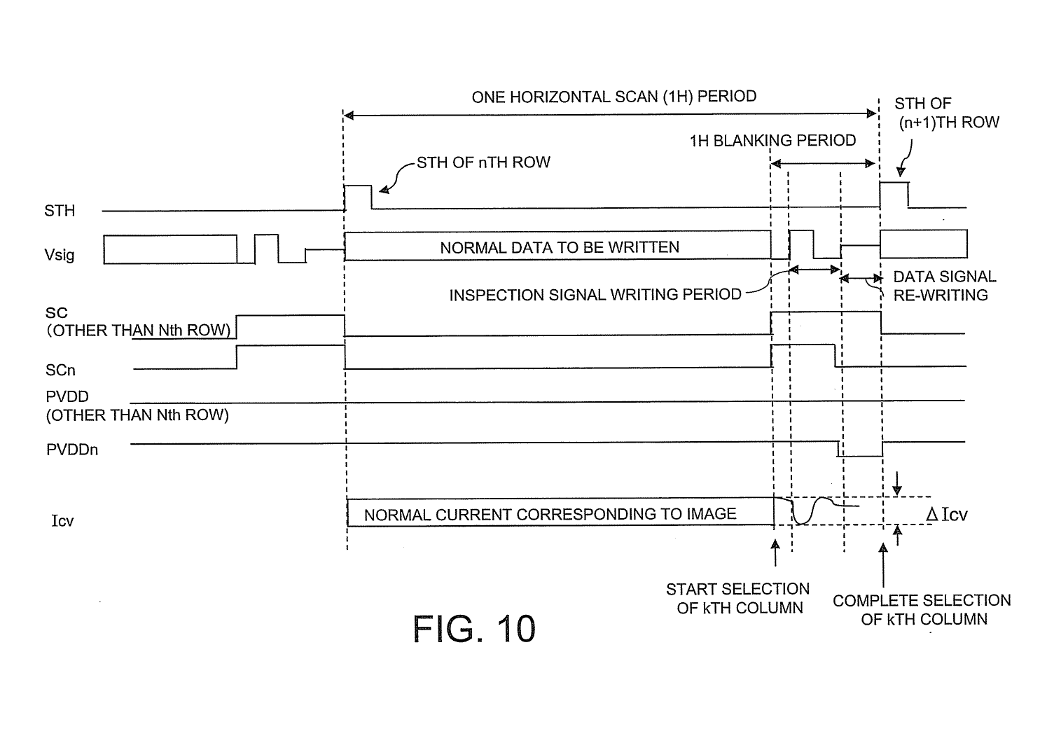

In driving method 1, the cathode electrode is formed common to all pixels as described above, and the cathode current is detected during the horizontal blanking period. The method will now be described with reference to a timing chart of driving method 1 shown in FIG. 10 exemplifying a case where a panel having a matrix of y rows and x columns is employed as the EL panel 100.

In the driving method 1, the inspection signal is supplied to pixels in kth column of a predetermined row during a horizontal blanking period, an inspection of pixels of all rows (n rows) for the kth column is executed through a frame period, and this process is repeated for y times to detect cathode currents for all pixels.

The horizontal start signal STH represents a start of one horizontal scan (1H) period. As shown in FIG. 10, a period from the rise of the nth STH to the rise of (n+1)th STH of the next row is the 1H period of nth row. At the end of the 1H period, a horizontal (H) blanking period is provided. During a period between the rise of the nth STH and the start of the H blanking period, all pixels on the nth row is selected as normal, display data Vsig is written to each pixel, the EL element emits light according to the data, and display is realized. The emission of the EL element is basically maintained until a data signal of the next frame is written to the same pixel at the next frame.

In this method, during the H blanking period of the 1H period of the nth row, an inspection signal (inspection ON display signal and inspection OFF display signal) Vsig is supplied from the data line 12 to a pixel of a predetermined column (kth column).

The inspection signal is a signal which allows the element driving Tr2 of the corresponding pixel to operate in the saturation region and having a predetermined amplitude to set the EL element to the non-emission state and the emission state as described above. A current shown in FIG. 10 as a cathode current Icv is obtained from the cathode electrode CV, the cathode current detecting unit 330 detects the ON cathode current and the OFF cathode current, and the calculation unit 360 calculates the difference, to obtain the ON-OFF current difference signal V (ΔIcv).

In this method, after the cathode current detecting unit 330 detects the cathode current, the data signal Vsig which has been maintained in the pixel to be measured until immediately before the measurement is again written to the pixel to be measured. This is done because, when the inspection signal is written to the pixel of kth column in nth row during the 1H blanking period, the normal writing data Vsig for the pixel is lost, and, thus, without such a process, display cannot be realized after the 1H period of the nth row until a new data signal Vsig is written to the pixel of nth row, kth column in the next frame.

Here, the potential on a capacitor line 14 (SC) provided for each row is set during the blanking period so that the voltage between the gate and the source of the element driving Tr2 |Vg−PVDD| does not exceed the operation threshold value |Vth|, in order to not block the cathode current detection during the blanking period. In other words, the potential is fixed on a first potential which sets the element driving Tr2 to a non-operation level in which the element driving Tr2 does not actively operate. With this setting, the EL element 18 connected to the element driving Tr2 is set to non-emission, and no cathode current occurs.

When the p-ch TFT is employed as the element driving Tr2 as shown in FIG. 1, the first potential is set to a predetermined High level (for example, a level identical to PVDD or the High level of the gate line 10).

In the above-description, the first potential of the capacitor line 14 is described as “non-operation level” of the element driving Tr2. However, because the storage capacitor Cs is connected to the gate of the element driving Tr2 when the inspection ON signal is supplied from the data line 12 through the selection Tr1 to the gate of the element driving Tr2, the gate potential Vg changes by a potential difference between the potential of the inspection ON signal and the predetermined gate potential of the capacitor line 14[n] fixed on the first potential. Therefore, when the gate potential of the element driving Tr2 is set to be sufficiently lower than the source potential (PVDD) (in the case where Tr2 is of the p-ch type) with the inspection ON signal, the element driving Tr2 can supply a corresponding current to the EL element according to the inspection ON signal.

The level of the capacitor line 14 may be set to the non-operation level of the element driving Tr2 for all rows during the H blanking period. However, in this method, for the capacitor line 14[n] of the nth row which is the inspection row, the potential is changed, during the re-writing period of the data signal, to a second potential (here, Low level; for example, GND) which is identical to the potential during the normal writing, to more reliably execute the re-writing process.

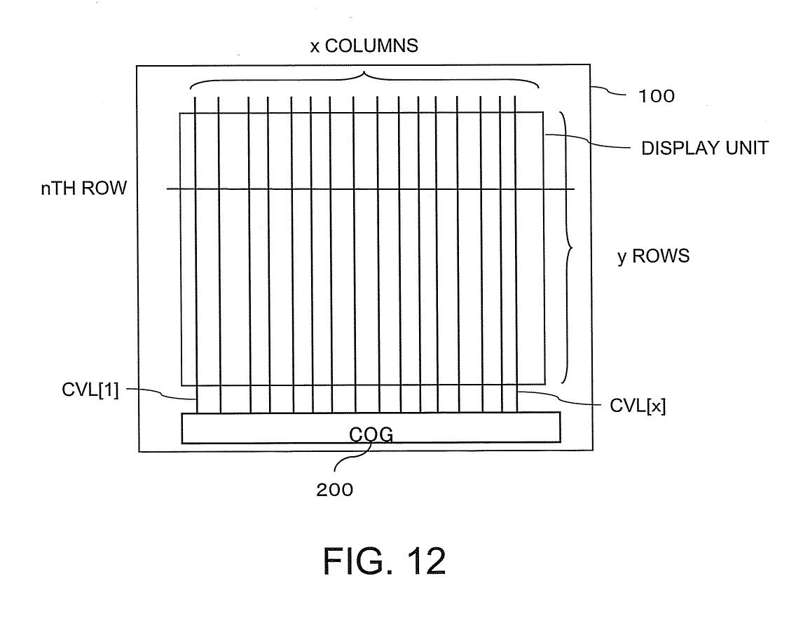

In addition, when a circuit structure is employed in which the power supply line 16 (PVDD) is formed for each row as shown in FIG. 12 to be described later and the potential can be controlled for each row, the power supply line 16[n] (PVDDn) of the nth row which is the inspection target may be changed to a predetermined Low level during a data signal re-writing period in the corresponding H blanking period. After the inspection signal is written, the PVDD potential of the row may be set to the Low level so that the data signal is written during the data signal re-writing period and the EL element can be set to the non-emission state at the same time. Because of this, it is possible to prevent occurrence of emission of the pixel (column) of the inspection target even though all pixels which are not to be inspected are set to non-emission state during the H blanking period and detection of the pixel as being bright during the emission period than the pixels which are not the inspection target.

In the case where the potentials of the capacitor line 14 and the power supply line 16 (PVDD) are controlled for the inspection row as described above, it is desirable that the potential of the capacitor line 14 be fixed at least during the re-writing period of the data signal. The timing of change of the capacitor line 14 from the first potential to the second potential which is the normal potential is set to a timing before the start of the re-write. As described, because the change of the potential of the power supply line from the normal potential to the low potential has an advantage of stopping the emission of EL element caused by supply of the inspection signal, it is desirable that the potential of the power supply line be changed before the start of the re-writing from the viewpoint of shortening an emission period which is unrelated to the display, but the timing of change may alternatively be set at a timing after the re-writing.

According to the driving method 1, the cathode current (ΔIcv) can be detected for all pixels in less than 11 seconds in a case of a VGA panel as already described.

(Driving Method 2)

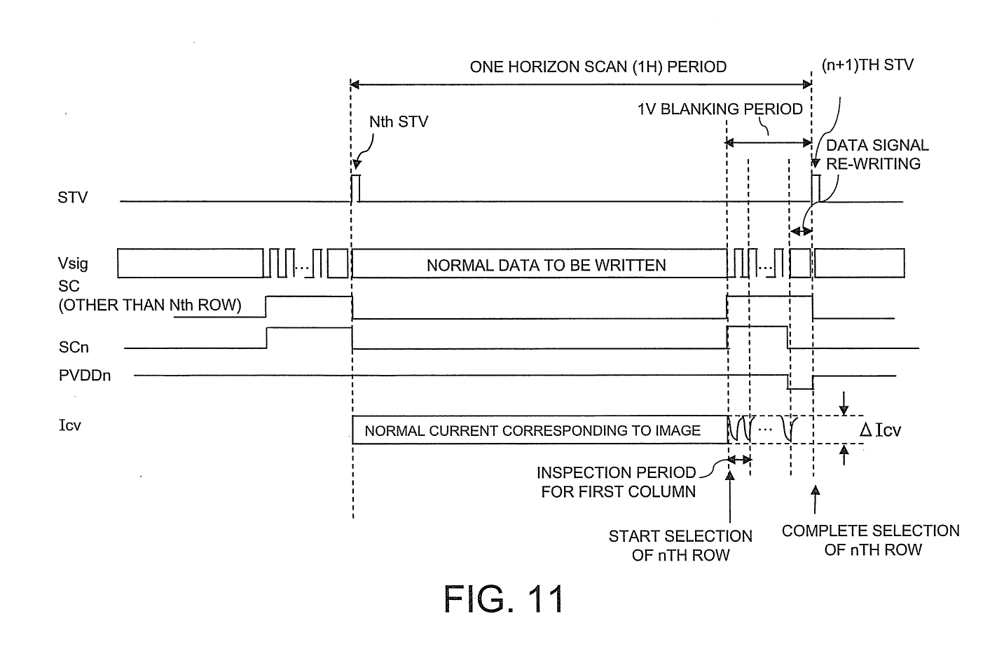

FIG. 11 is a timing chart related to driving method 2. In the driving method 2, the cathode electrode is formed common to the pixels and the cathode current is detected for all pixels belonging to one inspection row during a vertical blanking period.

In FIG. 11, a vertical start signal STV represents a start of one vertical scan (1V) period, and the 1V period of an nth frame is from a rise of the nth STV to the rise of the (n+1)th STV. At the end of the 1V period, a vertical (V) blanking period is provided.

During a period between the rise of the STV and the V blanking period, all pixels of the panel of y rows and x columns are selected as normal, the display data signal Vsig is written to each pixel, the EL element emits light according to the data signal, and display is realized.

In the driving method 2, all pixels of the nth row are selected from the start of the 1V blanking period, an inspection signal (ON and OFF display signals) Vsig is sequentially supplied from the data line 12 to all pixels on the nth row (first column to xth column), and a cathode current detection signal (V(ΔIcv)) is sequentially obtained at each column selection period (period in which the inspection signal is supplied to the corresponding column). After the writing of the inspection signal for all columns is completed, the display data signal which has been written to the pixel until before the inspection is re-written to all pixels of the nth row before the completion of the blanking period. Because the data line 12 is provided for each column, the respective display data can be written simultaneously for the pixels of all columns of the nth row.

Similar to the H blanking period in the above-described driving method 1, in the V blanking period, it is desirable that the potential of the capacitor lines 14 of all rows be set to the first potential corresponding to a non-operation potential of the element driving Tr2 and that, for only the capacitor line 14[n] of the inspection row, the potential be set to the second potential, in order to facilitate writing during a re-writing period in the inspection blanking period.

In addition, similar to the above-described driving method 1, when the power supply line 16 (PVDD) is provided for each row, it is possible to apply a control such that the power supply line PVDDn of the inspection row is changed to a predetermined Low level only during the re-writing period of the data signal, as shown in FIG. 11. By changing the potential of the power supply line PVDDn of the inspection row n after the writing of the inspection signal, the instantaneous emission period of the EL element caused by supply of the inspection signal can be inhibited to a shorter period.

With the above-described driving method 2, the cathode current (V(ΔIcv)) can be detected for all pixels in approximately 8 seconds in the case of a VGA panel, as already described.

(Driving Method 3)

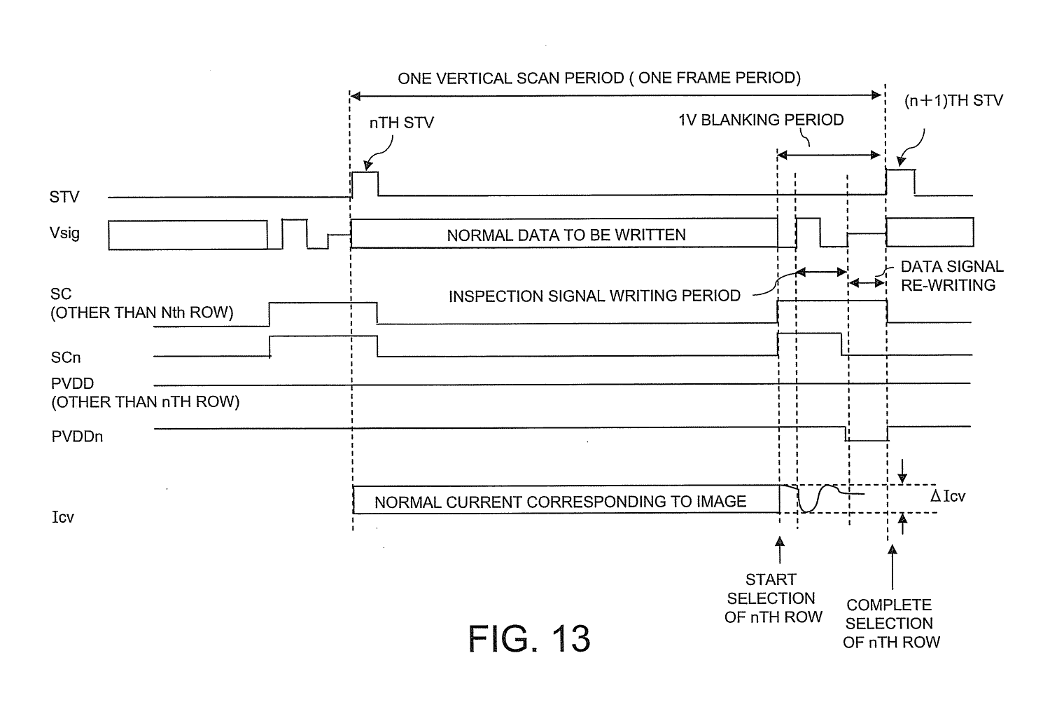

Next, driving method 3 will be descried with reference to FIGS. 12 and 13. In the driving method 3, as shown in the example structure of the panel of FIG. 12, the cathode electrode is divided for each column, and cathode electrode lines CVL are provided from CVL[1] to CVL[x]. In addition, as shown in FIG. 13, the detection of the cathode current is executed by selecting an inspection row (nth row) during the 1V blanking period of the nth vertical scan period, and cathode currents (V(ΔIcv)) are simultaneously detected for all pixels of the nth row (pixels from first column to xth column) using the cathode electrode line CVL for each column.

After the inspection signal writing period is completed, similar to the above-described driving method 2, the display data signal which has been written before the inspection signal is supplied is written to all pixels of the nth row before the corresponding V blanking period is completed.

Also similar to the above-described driving method 2, it is desirable to apply the potential control of the capacitor line 14 and the potential control of the power supply when the power supply line 16 (PVDD) is provided for each row. More specifically, the potential of the capacitor line 14 may be set to the first potential (non-operation potential of the element driving Tr2) during the V blanking period, and set to the second potential only for the capacitor line 14[n] of the inspection row, during the re-wiring of the data signal in the V blanking period during the inspection. Regarding the power supply line, only the power supply line PVDDn of the inspection row is set to the predetermined Low level during the re-writing period of the data signal, to stop the emission of the EL element caused by the supply of the inspection signal. Moreover, regarding the timing of the potential changes of the capacitor line 14[n] and the power supply line PVDDn, in particular, the potential change of the capacitor line 14[n], the potential is not changed during the re-writing period of the data signal.

With the driving method 3, the cathode current can be detected for one row during the 1V period, and the cathode current can be detected for all pixels in approximately 8 seconds as described above. In the driving method 3, because the cathode electrode is divided for each column, unlike the driving method 2, all periods other than the data signal re-writing period can be used for the inspection period for each column, resulting in reduction in the load of the driving circuit for outputting the inspection signal to the data lines 12 and reduction in the power consumption.

As shown in FIG. 12, each of the cathode power supply lines CVL[1]-CVL[x] divided in the driving method 3 is separately connected to the integrated driving circuit (driving unit) 200 mounted on the panel substrate through a COG (Chip On Glass) method. In the driving unit 200, for example, the current detection amplifier 332 as shown in FIG. 4 is provided in a one-to-one relationship with the cathode electrode lines CVL[1]-CVL[x], so that the cathode current can be detected simultaneously for all cathode electrode lines (all columns).

In addition, by correlating one current detection amplifier 332 to a plurality of lines (for example, 10 lines), it is possible to reduce the number of current detection amplifiers, which results in reduction of an area of the driving unit. When one current detection amplifier 332 is provided for each plurality of power supply lines, the cathode current detection process of the pixels of one row can be repeated for a number corresponding to the number of power supply lines correlated to one amplifier (for example, 10), to execute the inspection with a driver structure similar to that of the driving unit which executes the operation of FIG. 13.

Alternatively, the detection signal writing period in the 1V blanking period can be divided according to the number of power supply lines for one amplifier, and the cathode current can be sequentially detected from the correlated power supply lines CVL by one amplifier, to execute the cathode current detection for all pixels in a period similar to FIG. 13.

The driving unit 200 of FIG. 12 not only individually detects for the cathode electrode from the cathode electrode lines CVL, but also has functions shown in FIGS. 3 and 4, and executes driving of the display section, variation detection, variation correction, etc. In addition, for the driver 220 in the driving unit 220 shown in FIG. 3 (although not shown in FIG. 12), a part or all of the functions may be build on the panel substrate as the H driver and the V driver separately from the COG of FIG. 12, similar to the pixel circuit of the display section (refer to FIG. 1).

In addition, as already described, the driving method 3 in which the cathode electrode line is provided for each column may be employed in a method of executing the cathode current detection during a horizontal blanking period in one horizontal scan period.

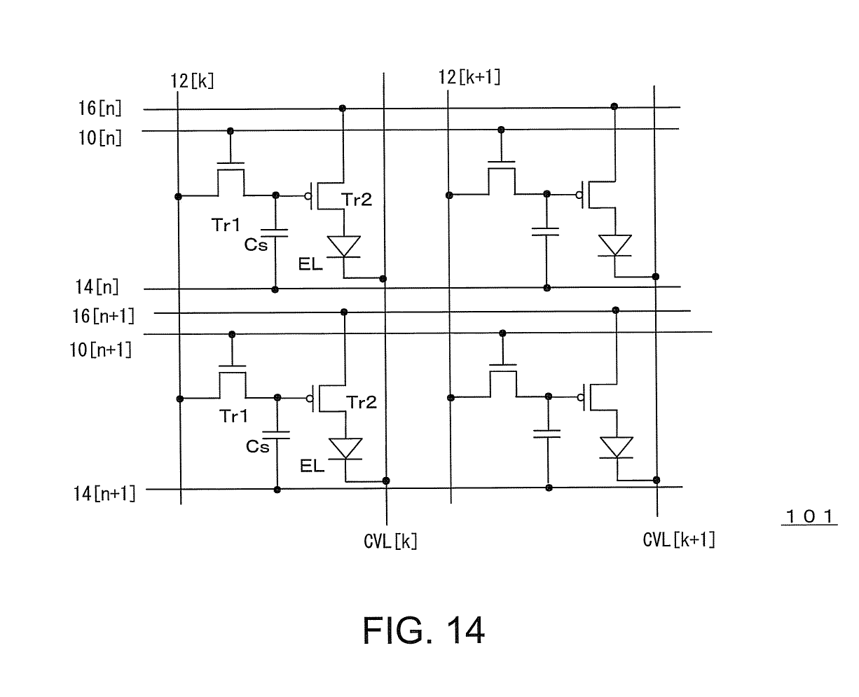

FIG. 14 shows a schematic circuit structure of a pixel circuit which can realize the driving method 3. The structure of FIG. 14 differs from the circuit structure of FIG. 1 in that the power supply line 16 (PVDD) is provided for each row and along the row direction instead of the column direction, and that the cathode electrode line CVL is provided for each column. When the cathode electrode is formed as an upper electrode and the anode electrode is formed as a lower electrode in the EL panel 100, the cathode electrode line CVL can be realized by forming the cathode electrode, which is to be formed above the EL layer, into a shape separate for each column. In the driving methods 1 and 2 also, when the potential of the power supply line 16 (PVDD) is to be controlled for each column, the power supply line 16 is formed along the row direction as shown in FIG. 14.

[Current Detection Amplifier]

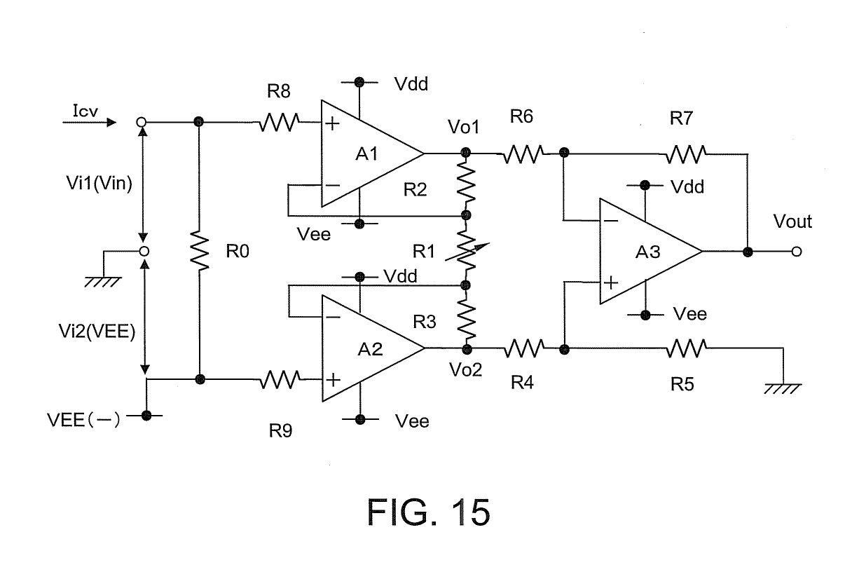

Next, an example structure of the current detection amplifier 332 will be described. In place of the current detection amplifier 332 shown in FIG. 4, an amplifier as shown in FIG. 15 may be employed, to detect the cathode current. The amplifier of FIG. 15 has a structure of a so-called instrumentation amplifier, and comprises three operational amplifiers A1, A2, and A3. A differential circuit is formed by the operational amplifiers A1 and A2, and the operational amplifier A3 functions as a differential amplifying circuit which amplifies a differential output of the operational amplifiers A1 and A2. By using such an instrumentation amplifier as the current detection amplifier, the device tends to not be influenced by the noise, and, it is possible to easily detect the cathode current with a high precision.

Resistors R2, R1, and R3 are connected in series between output terminals P1 and P2 of the operational amplifiers A1 and A2, and a connection point between the resistors R2 and R1 is connected to a negative input terminal of the amplifier A1. In addition, a connection point between the resistors R3 and R1 is connected to a negative input terminal of the operational amplifier A2.

On the other hand, a current detection resistor R0 is connected between positive input terminals of the operational amplifiers A1 and A2, and the cathode current Icv is supplied to the positive input terminal of the operational amplifier A1. In addition, a negative power supply voltage VEE is supplied to the positive input terminal of the operational amplifier A2 as an input signal Vi2. An input signal Vi1 (Vin) to the positive input terminal of the operational amplifier A1 becomes a value corresponding to a voltage generated by the cathode current Icv flowing through the current detection resistor R0 (Icv·R0) and the negative power supply voltage VEE, and is represented by VEE+Icv*R0.

When the output of the operational amplifier A1 is represented by Vo1 and the output of the operational amplifier A2 is represented by Vo2, Vo1 and Vo2 are determined by following Equations (3) and (4).

$$\begin{matrix}Vo 1 = ( 1 + \frac{R 2}{R 1} ) Vin - \frac{R 2}{R 1} \cdot VEE & ( 3 ) \\ Vo 2 = ( 1 + \frac{R 3}{R 1} ) VEE - \frac{R 3}{R 1} \cdot Vin & ( 4 )\end{matrix}$$

The difference between the two outputs is the output of the differential circuit portion, and is represented by following Equation (5).

$$Vo 1 - Vo 2 = ( Vin - VEE ) ( 1 + \frac{R 2 + R 3}{R 1} ) \qquad ( 5 )$$

Here, a resistance value of a resistor R6 connected to the side of the negative input terminal of the operational amplifier A3 and a resistance value of a resistor R4 connected to a side of the positive input terminal are equal, and a resistance value of a resistor R7 provided on a negative feedback path of the operational amplifier A3 and a resistance value of a resistor R5 provided between the ground (GND) and the positive input terminal of the operational amplifier A3 are equal. An output Vo from the operational amplifier A3 with respect to the ground potential is represented by following Equation (6).

$$Vo = \frac{R 7}{R 6} ( Vin - VEE ) ( 1 + \frac{R 2 + R 3}{R 1} ) \qquad ( 6 )$$

In the illustrated structure of FIG. 15, as described above, the negative power supply voltage VEE is supplied as an input signal to the positive input terminal of the operational amplifier A2 of the instrumentation amplifier. When it is intended to accurately detect a cathode current under a condition in which the element driving Tr2 operates in the saturation state (condition equivalent to normal display operation) in the EL panel, the cathode power supply is set at a potential which is lower than 0 V, for example, at −3 V. Therefore, in order to detect a cathode current at such a potential, a negative power supply VEE of an approximately same potential (such as −3 V) is necessary as an input signal Vo2 for comparison. In addition, as the operation power supplies of the operational amplifiers A1-A3, a positive operation power supply Vdd and a negative operation power supply Vee are necessary, and, of these, a voltage which is lower than VEE is necessary for the negative operation power supply Vee. For example, voltages of ±15 V are employed for Vdd and Vee.

When a large negative power supply is required in a display device which uses the EL panel 100 or the like, normally, a large negative power supply is generated from a relatively small negative voltage (for example, −1 V) which is used by the IC as a power supply, using a charge pump circuit or a switching regulator circuit. However, in many cases, a ripple component is superposed on the negative power supplies VEE and Vee generated using a charge pump circuit or the like. The cathode current to be detected in the preferred embodiment of the present invention, on the other hand, is small. Therefore, when the negative power supplies VEE and Vee as described above are employed as reference power supplies of a highly sensitive current detection amplifier, noises such as the ripple of the negative power supply may influence the detection result.

The output of the instrumentation amplifier having a structure as shown in FIG. 15, on the other hand, does not tend to be influenced by the power supplies Vdd and Vee of the operational amplifiers. In addition, as described above, because the input signal Vin to the operational amplifier A1 is represented by (VEE+Icv*R0) and the output signal Vo is represented by the Equation (6), the negative power supply voltage VEE is canceled in the final output signal Vo. Therefore, even when the current inspection is executed under a power supply condition similar to the normal display, the cathode current which is very small can be precisely detected without being influenced by the superposition of the noise by employing the instrumentation amplifier having a structure as shown in FIG. 15 as a current detection amplifier.

The negative power supply voltage VEE is desirably a voltage similar to the cathode power supply voltage Vcv, and, when a same drive power supply PVDD as the normal operation is employed as the drive power supply PVDD during current inspection, the voltages VEE and Vcv are set, for example, to a potential of approximately −3 V.

When, on the other hand, the potential of PVDD is set at a voltage higher than the normal operation by ΔV during the current detection, the cathode power supply voltage Vcv and the negative power supply voltage VEE can also be increased by ΔV, and a potential of approximately 0 V (GND) may be employed. In this case, a voltage which is smaller by at least ΔV (for example, ±10 V or ±5 V) may be employed as the drive power supplies Vdd and Vee of the amplifiers A1-A3. With this structure, the influence by the charge pump circuit or the like can further be reduced, and the power consumption in the current detection amplifier can be reduced. In addition, when the IV characteristic of the EL material of the EL element is sufficiently steep, a desired current Icv can be obtained with a small voltage amplitude difference. Therefore, in this case also, the power supply voltage range of the instrumentation amplifier can be set at a small value, and it is possible to realize lower power consumption and improvement of accuracy of the detection precision or the like with the use of the GND potential.

[Others]

In the above description, the method and the structure are described for a case in which the cathode current of each pixel is detected in real time. Alternatively, the current detection and correction processes may be executed also at the startup of the display device, or, a configuration may be employed in which the cathode current (ON-OFF current difference ΔIcv) of each pixel is measured at the time of shipping from the factory, correction data is stored in advance, and the correction data is updated at all times or correction is executed in real time while detecting a change with elapse of time of the characteristic. In particular, in the present embodiment, the cathode current detection data measured at the time of shipping from factory (initial data) may be stored in a non-volatile memory so that correction can be executed using the initial data at the time of startup of the power supply after the device is shipped from the factory.

The correction at the variation correcting unit 250 described above is not particularly limited in the calculation process and the correction processing method so long as the data signal to be ultimately supplied to a pixel in which display variation occurs is adjusted to a suitable level and the emission brightness of the EL element is corrected.

By integrating the variation detecting unit 300 described above with the panel controlling unit 210, it is possible to provide a display device which can execute detection and correction of display variation and control (display) at the display section with a very small driving unit. In addition, the structures in the variation detecting unit 300, for example, the A/D converter, latch circuit, calculation unit, and memory may be realized by a circuit of the panel controlling unit 210. When the driving unit 200 is made into an IC through such sharing of the functions, the IC chip size can be reduced.

In order to generate correction data for all pixels through the driving methods 1-3, for example, approximately 10 seconds or longer time is required. Because of this, if the cathode current is always detected in order from the uppermost row at the time of switching ON of the power supply of the device, in a display device having a short scanning time, the cathode current detection is repeatedly executed for pixels at the upper region, in particular, as the inspection time is elongated.

In consideration of this, the inspection controlling unit 310 shown in FIG. 3 or the like may store an address of a pixel in which the supply of the inspection signal and the detection of the cathode current are last executed before the device power supply is stopped or may always manage the address of the pixel in which the inspection is executed, and may control such that the inspection is executed from a pixel which is next to the last pixel in the previous inspection when the device power supply is next switched ON. In this process, the writing of the data to the memory 370 (data update) is directed to data corresponding to the address of the pixel which follows the address of the pixel to which the data is written immediately before stopping of the power supply. In such a control of inspection target and control of writing of the memory, the most recent inspection target and the pixel address in which the most recent correction data is obtained can be tracked by, for example, counting, with a counter, a horizontal start signal STH and a vertical start signal STV when the inspection is executed for each H blanking period or by counting a frame start signal STF generated from the above-described start signals STH and STV. Alternatively, the control of the pixel address of the inspection target and the control of the writing address of the memory may be realized through a method other than a counter.

With regard to the pixel to be inspected at the time of switching ON of the power supply, if the inspection target pixel at the time of the previous stopping of the power supply is in a middle of a row of the matrix of the panel, the inspection may be executed from the first pixel (first column) of that row when the power supply is next switched ON. A structure in which the inspection at the time of switching ON of the power supply is to be executed from the pixel address following the pixel address before the power supply is switched ON can be realized as a part of the V driver 210V to be built on the display panel 100 along with the pixel circuit. However, because the size of the circuit is increased in order to realize such a function, it is desirable to form the V driver 210V and the control signal generating circuit on the integrated circuit and mount on the panel through COG method or the like. In the integrated circuit in this case, all structures shown in the driving circuit 200 of FIG. 3 may be formed.

In the above description, an example case is described in which the cathode current of the EL element (for example, ΔIcv) is used as the current to be measured during inspection. Alternatively, the inspection may be executed based on a current Ioled (ΔIoled) flowing through the EL element. As the current Ioled flowing through the EL element, for example, an anode current Iano may be used in place of the cathode current Icv. When a configuration is employed in which the cathode electrode is set as the individual electrode for each pixel of the EL element and the anode electrode is set as the common electrode common to a plurality of pixels in place of a configuration in which the anode electrode is set as the individual electrode and the cathode electrode is set as the common electrode, the anode current (ΔIano) which is a current flowing through the common electrode as described above may be measured as described above.

What is claimed is:

1. A light emitting display device comprising:
a display section having a plurality of pixels arranged in a matrix form;
a variation detecting unit which detects an inspection result of display variation in the plurality of pixels; and
a correcting unit which corrects the display variation, wherein
each of the plurality of pixels in the display section comprises an electroluminescence element and an element driving transistor which is connected to the electroluminescence element and which controls a current flowing through the electroluminescence element,
the variation detecting unit comprises:
an inspection signal generating unit which generates an inspection signal to be supplied to a pixel of an inspection row and which supplies the inspection signal to the pixel of the inspection row at a predetermined timing during execution of display corresponding to a video signal;
a current detecting unit which detects a current flowing through the electroluminescence element generated corresponding to the inspection signal and which outputs a current detection signal; and
a memory unit which stores digital data corresponding to the current detection signal;
the correcting unit executes a variation correction according to each characteristic of the plurality of pixels on a digital data signal obtained from the video signal based on the digital data stored in the memory unit and generates a display data signal to be supplied to the plurality of pixels, and
the memory unit stores, according to a characteristic of the current detection signal, digital data having a smaller number of bits than that of the display data signal.

2. The light emitting display device according to claim 1, wherein
the inspection signal generating unit generates the inspection signal in a blanking period during execution of display corresponding to the video signal.

3. The light emitting display device according to claim 1, wherein
the current flowing through the electroluminescence element is a cathode current.

4. A light emitting display device comprising:
a display section having a plurality of pixels arranged in a matrix form;
a variation detecting unit which detects an inspection result of display variation in the plurality of pixels; and
a correcting unit which corrects the display variation, wherein
each of the plurality of pixels of the display section comprises a light emitting element and an element driving transistor which is connected to the light emitting element and which controls a current flowing through the light emitting element,
the variation detecting section comprises:
an inspection signal generating unit which generates, as an inspection signal to be supplied to a pixel of an inspection row, an inspection ON signal which sets the light emitting element to an emission level and an inspection OFF signal which sets the light emitting element to a non-emission level;
a current detecting unit which detects an ON-current flowing through the light emitting element when the inspection ON signal is applied and an OFF-current when the inspection OFF signal is applied and which obtains an ON-current detection signal and an OFF-current detection signal;
an analog-to-digital converter which converts the ON-current detection signal and the OFF-current detection signal into digital data, respectively; and
a memory unit which stores digital data corresponding to an ON-OFF current difference between a digital ON-current detection signal and a digital OFF-current detection signal,
the correcting unit executes a variation correction according to each characteristic of the plurality of pixels on a digital data signal obtained from the video signal based on the digital data corresponding to the ON-OFF current difference and generates a display data signal to be supplied to the plurality of pixels, and
a number of bits of the digital data corresponding to the ON-OFF current difference stored in the memory unit is less than a number of bits of the display data signal.

5. The light emitting display device according to claim 4, wherein
a possible range of the digital data corresponding to the ON-OFF current difference is determined based on a change allowance range of the ON-current detection signal and of the OFF-current detection signal; and
when the digital data corresponding to the ON-OFF current difference is represented with N bits, data of bit positions of (N−1)th bit or lower, among the N bits, which may change is stored in the memory unit as the digital data corresponding to the ON-OFF current difference according to the possible range of the digital data corresponding to the ON-OFF current difference.

6. The light emitting display device according to claim 5, wherein
the analog-to-digital converter outputs only the data of positions of (N−1)th bit or lower corresponding to the change allowance ranges of the ON-current detection signal and of the OFF-current detection signal as a digital ON-current detection signal and a digital OFF-current detection signal corresponding to the ON-current detection signal and the OFF-current detection signal, respectively.

7. The light emitting display device according to claim 4, wherein
the memory unit stores, when the digital data corresponding to the ON-OFF current difference is represented with N bits, data of bit positions of (N−1)th bit or lower, among the N bits, which may change according to a change allowance range of the digital data corresponding to the ON-OFF current difference, as the digital data corresponding to the ON-OFF current difference.

8. The light emitting display device according to claim 7, wherein
the analog-to-digital converter outputs, of the N-bit digital data corresponding to the ON-current detection signal and to the OFF-current detection signal, respectively, only the data of bit positions of (N−1)th bit or lower which may change according to the change allowance range of the digital data corresponding to the ON-OFF current difference.

9. The light emitting display device according to claim 4, further comprising:
a calculation unit which determines the digital data corresponding to the ON-OFF current difference based on the digital ON-current detection signal and the digital OFF-current detection signal, wherein
the calculation unit determines the digital data of N bits corresponding to the ON-OFF current difference based on the digital ON-current detection signal and the digital OFF-current detection signal, and
the memory unit stores digital data corresponding to the ON-OFF current difference having a number of bits of (N−1) or less obtained by omitting a lower significant bit of the N bits according to a precision of the digital ON-current detection signal and of the digital OFF-current detection signal.

10. The light emitting display device according to claim 4, wherein
the analog-to-digital converter converts the ON-current detection signal and the OFF-current detection signal into digital data having a number of bits of (N−1) or less according at least to a precision of the ON-current detection signal when the number of bits of the display data signal is N, and
the memory unit stores digital data corresponding to the ON-OFF current difference having a number of bits of (N−1) or less obtained from the digital ON-current detection signal and the digital OFF-current detection signal having the number of bits of (N−1) or less.

11. The light emitting display device according to claim 4, wherein
of the digital ON-current detection signal and the digital OFF-current detection signal which are used for determination of the digital data corresponding to the ON-OFF current difference,
the digital ON-current detection signal is a signal which is updated every time the inspection signal generating unit supplies the inspection ON signal to a corresponding pixel and a new ON-current detection signal is obtained, and
the digital OFF-current detection signal is a signal which is determined and set in advance.

12. The light emitting display device according to claim 11, wherein
the set signal is a digital OFF-current detection signal corresponding to an OFF current which is obtained when the inspection OFF signal is supplied to a particular pixel or when the inspection OFF signal is periodically supplied to a corresponding pixel at a predetermined period.

13. The light emitting display device according to claim 4, wherein
the inspection signal generating unit generates the inspection signal in a blanking period during execution of display corresponding to the video signal.

14. The light emitting display device according to claim 4, wherein
the current flowing through the light emitting element is a cathode current.
